(19) United States
(12) Patent Application Publication
(10) Pub. No.: US 2010/0280922 A1
(43) Pub. Date: Nov. 4, 2010

(54) ILLUMINATION AND DECORATION FOR AMPLIFIER AND SPEAKER NETWORKS

(76) Inventor: Roberto Michele Giovannotto, Palo Alto, CA (US)

Correspondence Address: Thomas E. Lees, LLC, 67 Rhoads Center Drive, Dayton, OH, 45458, US

(21) Appl. No.: 12/772,175

(22) Filed: May 1, 2010

Related U.S. Application Data
(60) Provisional application No. 61/174,770, filed on May 1, 2009.

(51) Int. Cl. G06Q 30/00; H05B 37/02; G06Q 50/00

(52) U.S. Cl. 705/27; 315/307; 315/297

(57) ABSTRACT

An illumination system is driven by a speaker level, audio frequency signal. The illumination system utilizes active current limiting circuitry electrically coupled between an input that receives the speaker level audio frequency signal and an illumination arrangement having at least one illumination device, such as a light emitting diode. The active current limiting circuitry has at least one active semiconductor device for limiting the current allowed to pass there through. As such, an illumination device is coupled to the active current limiting circuitry so as to be driven by the audio frequency speaker level signal received by the input in such a way that the active current limiting circuitry limits the current delivered to at least one illumination device. The illumination system can also include other systems including a digital controller, filters and other circuitry.

### CROSS-REFERENCE TO RELATED APPLICATIONS

This application claims the benefit of U.S. Provisional Patent Application No. 61/174,770, entitled “Illumination and Decoration System, Method, and Process for Amplifier and Speaker Networks”, filed May 1, 2009, the disclosure of which is hereby incorporated by reference in its entirety.

### BACKGROUND

Embodiments of the present invention relate to illumination and/or decoration systems for speakers, corresponding speaker cabinets and amplifier systems that drive such speakers, to provide visual enhancement of music and sound.

Performers including singers and musicians utilize the medium of sound for the expression of their art. In this manner, performers arrange sounds into compositions in such a way as to create or invoke feelings or emotion, tell stories, etc. Often, performers utilize amplifiers and corresponding loudspeaker cabinets to amplify and project performances to their audience. However, the expression of sound through music and the corresponding listening experience of an audience can be enhanced by combining sound with light displays, costumes, stage sets and other visual devices by representing sound produced by loudspeakers, especially music, in a visual medium.

### BRIEF SUMMARY

According to various aspects of the present invention, an illumination system comprises an input, active current limiting circuitry and an illumination arrangement. The input receives a speaker level, audio frequency signal. The active current limiting circuitry is electrically coupled to the input. Moreover, the active current limiting circuitry has at least one active semiconductor device for limiting the current allowed to pass there through. The illumination arrangement has at least one illumination device coupled to the active current limiting circuitry so as to be driven by the audio frequency speaker level signal received by the input in such a way that the active current limiting circuitry limits the current delivered to at least one illumination device.

According to further aspects of the present invention, an illumination system comprises an input, active current limiting circuitry, an illumination arrangement and a control device. The input receives a speaker level, audio frequency signal. The active current limiting circuitry has at least one active semiconductor device for limiting the current allowed to pass there through. The illumination arrangement has at least one illumination device coupled to the active current limiting circuitry in such a way that the active current limiting circuitry limits the current delivered there to. The control device is positioned between the input and the active current limiting circuitry. Moreover, the control device has at least a first state wherein the active current limiting circuitry electrically couples the input carrying the speaker level, audio frequency signal to the illumination arrangement and a second state wherein the active current limiting circuitry is electrically disconnected from the input and is electrically connected to a control source.

According to still further aspects of the present invention, an illumination system comprises an input, a digital controller and an illumination arrangement. The input receives a speaker level, audio frequency signal. The digital controller is powered by the speaker level audio frequency signal derived from the input. The illumination arrangement is organized into a plurality of channels, each channel comprising at least one illumination device. Moreover, the illumination system comprises a plurality of switches, each switch uniquely associated with a corresponding one of the channels. Still further, the illumination system is configured such that each channel is coupled between a corresponding one of the switches and a connection that receives the speaker level, audio frequency signal. The digital controller comprises an output coupled to a control input of each switch such that each illumination device of a corresponding channel is controlled to illuminate at least during the simultaneous occurrence of an audio frequency speaker level signal capable of providing sufficient current to illuminate the corresponding channel, and the digital controller closing the corresponding switch.

According to still further aspects of the present invention, a method of enabling a customer to design a decorative attribute of a loudspeaker, comprises receiving a submission of a graphical design from a customer via a computer interface over the internet, printing a speaker with the graphics design submitted by the customer and shipping the printed speaker to the customer. The method may further comprise modifying the speaker to include at least one illumination device that is driven to illuminate according to the signal applied to the voice coil of the speaker. The illumination circuitry added to the speaker may also include digital controller circuitry. In this regard, the method may further comprise programming the digital controller circuitry before shipping the speaker to the customer to include at least one predetermined program sequence. Moreover, the method may include providing an interface, e.g., to allow the customer to design the programmed sequence loaded into the digital controller circuitry and/or to design the graphic printed onto the speaker.

### BRIEF DESCRIPTION OF THE SEVERAL VIEWS OF THE DRAWINGS

The following detailed description of various embodiments and other aspects of the present invention can be best understood when read in conjunction with the following drawings, where like structure is indicated with like reference numerals, and in which:

FIG. 1 is a block diagram illustrating an amplifier system, including an amplifier, a speaker cabinet and an illumination system according to various aspects of the present invention;

FIG. 2 is illuminated amplifier system illustrating several exemplary locations for illumination according to various aspects of the present invention;

FIG. 3 is a block diagram of the components of an illumination circuit according to various aspects of the present invention;

FIG. 4 is a schematic diagram illustrating an exemplary circuit implementation for active current limiting of illumination devices according to various aspects of the present invention;

FIG. 5 is a schematic of an illumination circuit comprising a digital controller powered by a speaker level audio signal, according to various aspects of the present invention;

FIG. 6 is a schematic diagram of an illumination circuit having a switchable input to accommodate control by an external light controller, according to various aspects of the present invention;

FIG. 7 is a schematic diagram illustrating various exemplary optional filtering and/or conditioning arrangements for illumination device control, according to various aspects of the present invention;

FIG. 8 is a loudspeaker illustrating placement of a light source directly behind the loudspeaker magnet and projected to a light dispersing device according to various aspects of the present invention;

FIG. 9 is a loudspeaker illustrating placement of the light sources directly beneath the dust cap according to various aspects of the present invention;

FIG. 10 is a loudspeaker illustrating placement of the light sources around the outside periphery of the loudspeaker motor according to various aspects of the present invention;

FIG. 11 illustrates a process wherein a customer of a loudspeaker may select and/or design the graphics to be subsequently printed on loudspeakers and shipped to customer, according to various aspects of the present invention; and

FIG. 12 illustrates process wherein a user of a loudspeaker may program a lighting sequence and upload the file to a desired loudspeaker, according to various aspects of the present invention.

### DETAILED DESCRIPTION

In the following description, reference is made to the accompanying drawings that form a part hereof, and in which is shown by way of illustration, and not by way of limitation, various alternative arrangements for implementing aspects of the present invention. It is to be understood that other embodiments may be utilized and that changes may be made without departing from the spirit and scope of the present invention.

Various aspects of the present invention relate to the integration of illumination systems with speakers and/or speaker cabinets and/or electronic circuitry, such as amplifiers and effects processors, which supply signals and power to the speaker(s). Illumination provides both visual appeal and a system for interactive feedback between user and the electronics and/or speaker system. As will be described in greater detail herein, the illumination system may be powered by the same alternating signal, e.g., an audio frequency, speaker level signal, that drives a loudspeaker voice coil of a corresponding speaker so that no external power supply or additional wiring is required. Moreover, the illumination system may be user-adjustable and/or configurable, e.g., via user programming of one or more controls, such as potentiometers, switches, etc. Still further, the illumination system may optionally be programmed or programmable through electronic control, e.g., via a control signal communicated through the audio frequency speaker level signal that drives the speaker, through a dedicated programming signal, via wireless programming or by utilizing other suitable techniques.

Moreover, various aspects of the present invention provide methods and processes to provide speakers having their speaker cones printed with various images, texts, logos, etc., to increase user appeal and improve marketing, branding and visibility. The utilization of customized speaker printing is particularly effective when combined with various illumination systems described more fully herein.

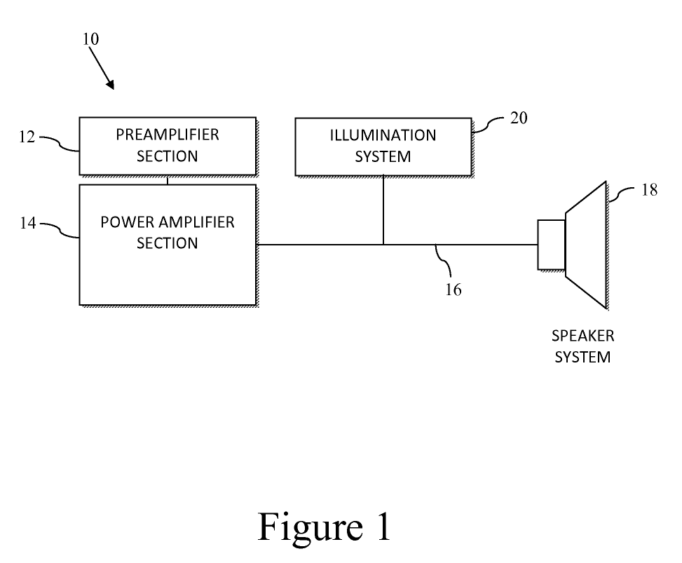

Referring now to the drawings and particularly to FIG. 1, a block diagram illustrates an amplifier system 10 according to aspects of the present invention. The amplifier system 10 includes in general, an amplifier having a speaker level output that is connected to a speaker system. Moreover, an illumination system is coupled to the speaker level output of the amplifier to drive an illumination arrangement in accordance with a signal appearing on the speaker level output. According to further aspects of the present invention, the illumination system can derive its power from the signal appearing on speaker level output, as will be described in greater detail herein.

In general, a typical amplifier may include a pre-amplifier section 12 coupled to a power amplifier section 14. The pre-amplifier section 12 receives a suitable input signal, such as from a microphone, instrument, line level or low-level signal source, and provides the desired pre-amplification and/or optional signal conditioning, equalization, processing, etc. desired by a corresponding user. The power amplifier section 14 converts the audio frequency signal received from the preamplifier section 12 to an output signal such as a speaker level, audio frequency signal. In practice, the preamplifier section 12 may be integrated with the power amplifier section 14, or the preamplifier section 12 and the power amplifier section 14 may be individual components that are coupled together.

The speaker level output of the power amplifier section 14 drives the speaker level audio frequency signal, typically through a speaker cable 16, to a corresponding speaker system 18. In this regard, the speaker system 18 may include one or more speaker cabinets, each speaker cabinet housing one or more speakers. More particularly, the power amplifier section 14 typically delivers the speaker level audio frequency signal via the speaker cable 16 to the voice coil(s) of the corresponding speaker(s) as an opposing phase AC signal to convert the audio signal to sound.

The amplifier system 10 is presented by way of illustration and not by way of limitation to demonstrate general exemplary components of electronic equipment and speakers that deliver the sound, e.g., to an artist and/or audience. In practice, the amplifier system 10 can be implemented using any amplifier topology including vacuum tubes, solid-state, etc. Moreover, additional electronics may be utilized, such as cross-over networks, etc. Still further, the speaker system, including the speaker cabinet(s) and/or speakers themselves, can be implemented in any desired manner.

As noted in greater detail herein, the electronic equipment and/or speaker cabinets and/or speakers that deliver the sound, e.g., to the artist and/or audience, may also benefit from visual enhancement. In this regard, according to various aspects of the present invention, a visual enhancement of music and sound is provided by including an illumination system 20 that is illustrated as being coupled to the speaker level output of the power amplifier section 14.

As will be described in greater detail herein, the illumination system 20 can be located at any position downstream of the electronics that convert an input signal to a speaker level audio frequency signal, e.g., downstream of the power amplifier section 14 in the illustrative example. In this manner, the illumination system 20 is controlled, at least in part, by the audio frequency, speaker level output of the power amplifier section 14. Moreover, as will be described in greater detail herein, the illumination system 20 is composed of several components which can be integrated together over distributed throughout the amplifier system 10.

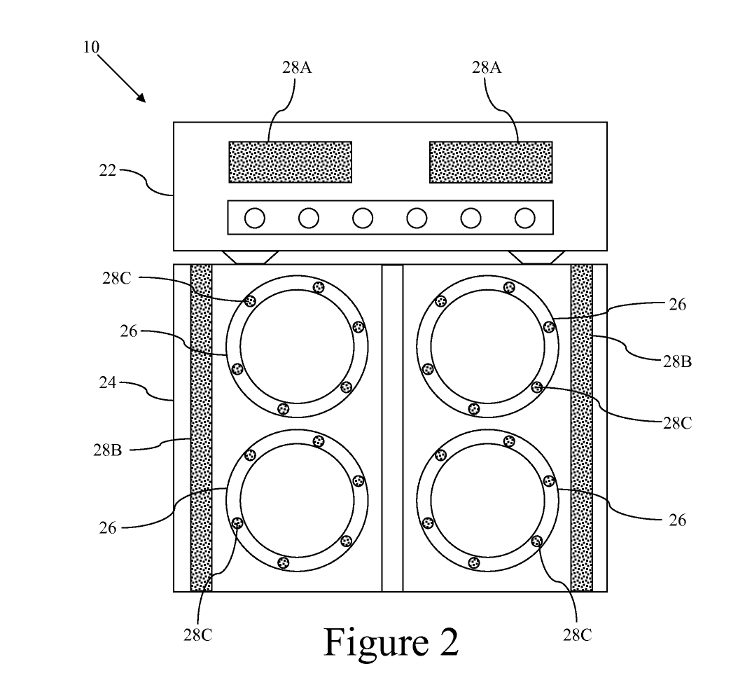

Referring to FIG. 2, an exemplary amplifier system 10 is illustrated in the context of a guitar amplification system having an amplifier 22 connected to a speaker cabinet 24. The amplifier 22 converts a low level signal, such as from an electric guitar, to a speaker level audio frequency signal. In this manner, the amplifier 22 may integrate both the preamplifier section 12 and power amplifier section 14 described with reference to FIG. 1. The speaker level audio frequency signal is coupled to a speaker cabinet 24 to drive the speakers 26 located therein. In this manner, the speaker cabinet 24 and corresponding speakers 26 implement the speaker system 18 described with reference to FIG. 1. By way of illustration, the illumination system 20 is utilized to control one or more illumination devices in response to the output of the amplifier 22, e.g., to provide illumination in synchronization with the output signal generated by the amplifier 22.

According to various aspects of the present invention, illumination devices can be positioned at any suitable location within the guitar amplification system. For instance, the illumination system 20 can control one or more illumination devices to generate illumination 28A that radiates from the amplifier 22. In addition and/or alternatively, the illumination system 20 can control one or more illumination devices to generate illumination 28B that radiates from the speaker cabinet 24, such as along a front baffle, side edge or other designated position associated with the speaker cabinet 24. In addition and/or alternatively, the illumination system 20 can control one or more illumination devices to generate illumination 28C that radiates from one or more of the speakers 26 located within the speaker cabinet 24. The integration of illumination devices integral with speakers 26 will be described in greater detail herein.

In this regard, the amplifier 22 and/or speaker cabinet 24 and/or speaker(s) 26 may be illuminated in a manner that corresponds to the audio signal processed by the power amplifier section 20. This provides an intriguing visual display that follows the audio generated by the amplifier 12.

According to further aspects of the present invention, illumination systems are provided, which are powered by the same audio signal that drives the voice coils of speakers 26. By employing the very same cable and wires to drive speakers and illumination systems, greater simplicity and reliability are maintained. For instance, there is no need for an additional power source. Moreover, although described in general with reference to a single illumination system 20, in practice, multiple instances of illumination system 20 may be distributed throughout the amplifier system 10. For example, a first instance of an illumination system 20 may be implemented within the amplifier 22. Correspondingly, a second instance of an illumination system 20 may be implemented within the speaker cabinet 24. Under this arrangement, the first and second instances of the illumination system may have similar and/or different features, circuitry, capabilities, etc., depending upon the desired illumination effect.

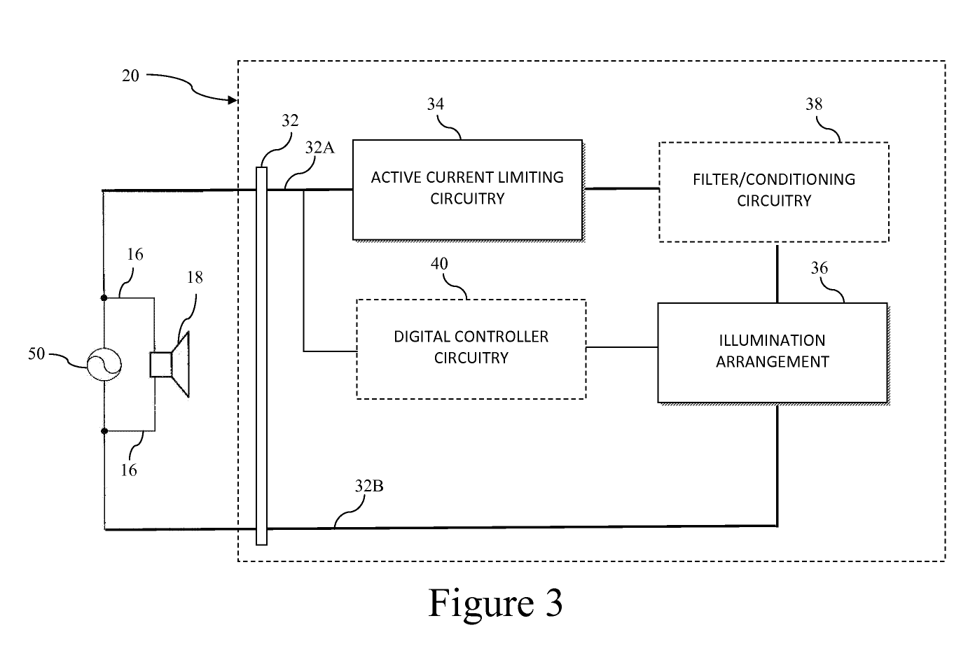

Referring to FIG. 3, exemplary components of an illumination system 20 are illustrated according to various aspects of the present invention. In general, the illumination system 20 includes an input 32, active current limiting circuitry 34 and an illumination arrangement 36. The input 32 receives a speaker level, audio frequency signal, e.g., typically from a power amplifier section 14 described with reference to FIG. 1. The illumination system 20 may also optionally include one or more additional components such as filter/conditioning circuitry 38 and/or digital controller circuitry 40.

The input may, for example, distribute the speaker level audio frequency signal along signal lines 32A, 32B to the other components of the illumination system.

The active current limiting circuitry 34 is electrically coupled to the input 32 and includes at least one active semiconductor device for limiting the current allowed to pass there through to the illumination arrangement 36. This provides an active protection scheme that prevents damage to the illumination device(s) such as due to the illumination system 20 being connected to an audio frequency signal source having power that exceeds the designed limits of the illumination devices. Moreover, according to various aspects of the present invention, the active current limiting capabilities are implemented without requiring additional power sources to power the active devices in the current limiting circuitry.

The illumination arrangement 36 comprises at least one illumination device coupled to the active current limiting circuitry so as to be driven by the audio frequency speaker level signal received by the input 32 in such a way that the active current limiting circuitry 34 limits the current delivered to at least one illumination device. For instance, the illumination arrangement 36 may comprise one or more illumination devices, such as light emitting diodes (LEDs) or other sources or devices that are capable of generating light.

The optional filter/conditioning circuitry 38 may provide active and/or passive filtering, such as for selective illumination based upon signal level, frequency content of the speaker level audio signal that drives the illumination system 20, etc. The optional filter/conditioning circuitry 38 may also provide passive components, such as resistors or other electrical components required for circuit implementations using certain illumination devices such as light emitting diodes. Still further, the optional filter/conditioning circuitry 38 may provide controls such as potentiometers, switches or other devices for programming the response of the illumination device(s) of the illumination arrangement 36, e.g., to set a brightness level, to set a desired color, to set a timing or responsiveness, or to perform other conditioning tasks.

The optional digital controller circuitry 40 draws power from the speaker level audio frequency signal, and can provide a number of programmable control options to control the illumination devices of the illumination arrangement 36. For instance, the digital controller circuitry 40 may execute a preprogrammed sequence for a fixed routine, or may have the program sequences actively loaded or triggered during the performance. In this regard, the digital controller may generate control signals that drive semiconductor switches, e.g., to duty cycle modulate the illumination intensity of lights associated with the illumination arrangement 36, examples of which are described in greater detail herein.

In an illustrative example, a speaker level audio frequency signal 50, such as may be output by the power amplifier section 14 illustrated in FIG. 1, or the amplifier 22 of FIG. 2, is coupled via the speaker cabling 16 to a voice coil of a speaker within the speaker system 18. The input 32 of the illumination system 20 also receives a copy of the speaker level audio frequency signal 50. In the illustrative example, the input 32 couples the opposing phases of the speaker level audio frequency signal 50 to the illumination arrangement along the signal lines 32A, 32B respectively. The illumination arrangement 36 includes at least one illumination device coupled to the input 32 and corresponding signal lines 32A, 32B, e.g., through the active current limiting circuitry 34 and optionally, the filter/conditioning circuitry 38. The illumination device(s) are thus powered by the same alternating signal, e.g., the audio frequency, speaker level signal, that drives the speaker system 18.

Moreover, the illumination devices of the illumination arrangement 36 may optionally be controlled by the digital controller circuitry 40, e.g., if provided. Moreover, one or more of the components of the illumination system 20, e.g., one or more of the active current limiting circuitry 34, illumination arrangement 36, the filter/conditioning circuitry 38 and the digital controller circuitry 40, may comprise one or ore adjustable controls. For instance, user adjustable control, such as via a potentiometer, switch, etc., may be provided to set a threshold limit for current or power delivered to the illumination devices, set the color of the illumination devices, adjust the number of illumination devices, intensity of the illumination devices, etc. Additionally, such features may be programmed and controlled, e.g., via commands from the digital controller circuitry 40.

Still further, the various components of the illumination system 20 can be distributed. For instance, illumination devices of the illumination arrangement 36 may be physically located on or within a speaker 26 as described in greater detail herein, whereas the active current limiting circuitry 34, digital controller 40, etc., may be located at a different physical location, e.g., at a different physical location on the speaker 26 that contains the illumination devices, within a corresponding speaker cabinet, amplifier, etc. In this regard, distributed components may be coupled, e.g., along the signal lines 32A, 32B.

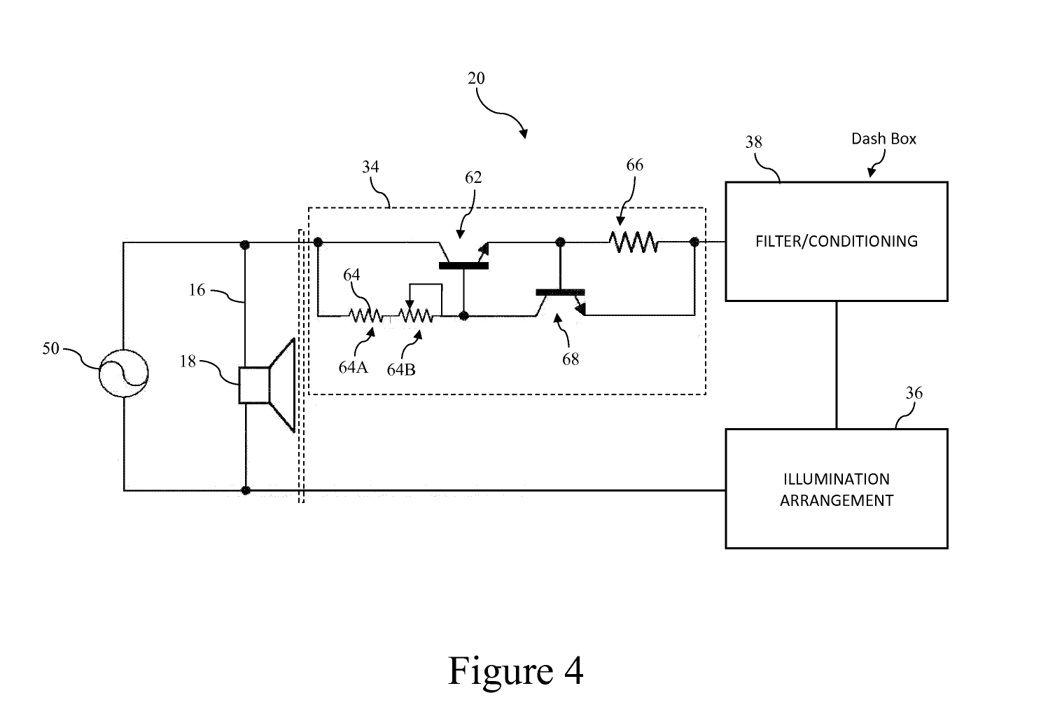

Referring to FIG. 4, an exemplary implementation of the active current limiting circuitry 34 is illustrated. In the exemplary implementation of FIG. 4, an opposing phase AC signal source, e.g., the speaker level audio frequency signal 50, supplies an audio frequency signal to speaker system 18 and to the illumination system 20 as described in greater detail herein. In this manner, the active current limiting circuitry 34 and the illumination arrangement 36 are powered entirely by the speaker level audio frequency signal 50. Where the illumination arrangement is comprised of one or more light emitting diodes (LEDs), the exemplary active current limit circuitry 34 establishes a maximum LED array conduction current.

The active current limiting circuitry 34 comprises a pass transistor 62, a bias resistor 64, a current sensing resistor 66 and a current sensing transistor 68. The pass transistor 62 normally allows an audio frequency, speaker level signal applied to the input 32, to pass there through. The bias resistor 64 sets up forward network conduction of the pass transistor 62 during normal operation. The current sensing resistor 66 is provided in series with the pass transistor 62 and measures the audio frequency, speaker level signal passing there through. The current sensing transistor 68 is coupled to the current sensing resistor, and is configured to control the pass transistor 62 when the current through the current sensing resistor 66 obtains a predetermined current limiting value.

More particularly, the pass transistor 62 and the current sensing transistor 68 are implemented in the illustrative example as bipolar junction transistors, each having a collector, an emitter and a base. The collector of the pass transistor 62 is coupled to the input 32 for receiving the audio frequency, speaker level signal 50. The emitter of the pass transistor 62 is coupled to the base of the current sensing transistor 68. The current sensing resistor 66 is coupled between the base and the emitter of the current sensing transistor 68. Still further, the collector of the current sensing transistor is coupled to the base of the pass transistor. Moreover, the bias resistor 64 is coupled between the collector and the base of the pass transistor 62.

According to various aspects of the present invention, the bias resistance can be made variable to provide adjustable control of the current limiting threshold of the active current limiter. For instance, the bias resistance can be established by a fixed resistor 64A and a variable resistance 64B, e.g., a potentiometer connected as a rheostat.

In operation, both the pass transistor 62 and the current sensing transistor 68 are configured as emitter followers. Each behaves basically like a switch that is turned on and off depending upon the voltage appearing at their respective bases. Normally, the bias resistor 64 in cooperation with the collector of the current sensing transistor 68 keep the base of the pass transistor 62 high. The pass transistor 62 thus acts like a closed switch passing the speaker level audio signal to the illumination arrangement 36.

The current sensing transistor 68 senses the current passing through the current sensing resistor 66 by virtue the voltage drop across the current sensing resistor 66, which appears between the base and emitter junctions of the current sensing transistor 68. Given a designed-for current limiting threshold, the current sensing transistor 68 will turn on and begin to conduct. Moreover, the collector of the current sensing transistor 68, which is coupled to the base of the pass transistor 62, will decrease the base voltage of the pass transistor 62, correspondingly decreasing the output voltage at the emitter of the pass transistor 62.

Thus, for example, should a voltage from the speaker level audio frequency signal 50 be sufficient to exceed a predetermined threshold, e.g., a threshold that would otherwise result in damaging the LED or LED arrays of the illumination arrangement 36, the active current limit circuitry 34 provides the necessary protection by causing conduction of the current limiting transistor 68 such that the pass transistor 62 looses sufficient base to emitter bias current to remain in conduction, whereby limiting system current to at least one illumination device of the illumination arrangement 36.

According to still further aspects of the present invention, the active current limiting circuitry 34 can be reconfigured for bi-directional current limiting, e.g., where bi-directional LEDs are utilized as illumination devices within the illumination arrangement 36.

According to various aspects of the present invention, the illumination arrangement 36 comprises a plurality of illumination devices implemented as light emitting diodes. In this regard, the active current limiting circuitry 34 can act as a master current limiter for all of the light emitting diodes. Alternatively, as another illustrative example, the illumination arrangement 36 may comprise a plurality of illumination devices, e.g., implemented as light emitting diodes. In this regard, the light emitting diodes may be organized into a plurality of channels, each channel comprising at least one light emitting diode. Moreover, the active current limiting circuitry 34 may comprise at least one active semiconductor device for limiting the current allowed to pass to each channel such that each channel has independent current limiting. For instance, each channel can include its own instance of the pass transistor 62, bias resistor 64, current sensing resistor 66 and current sensing transistor 68.

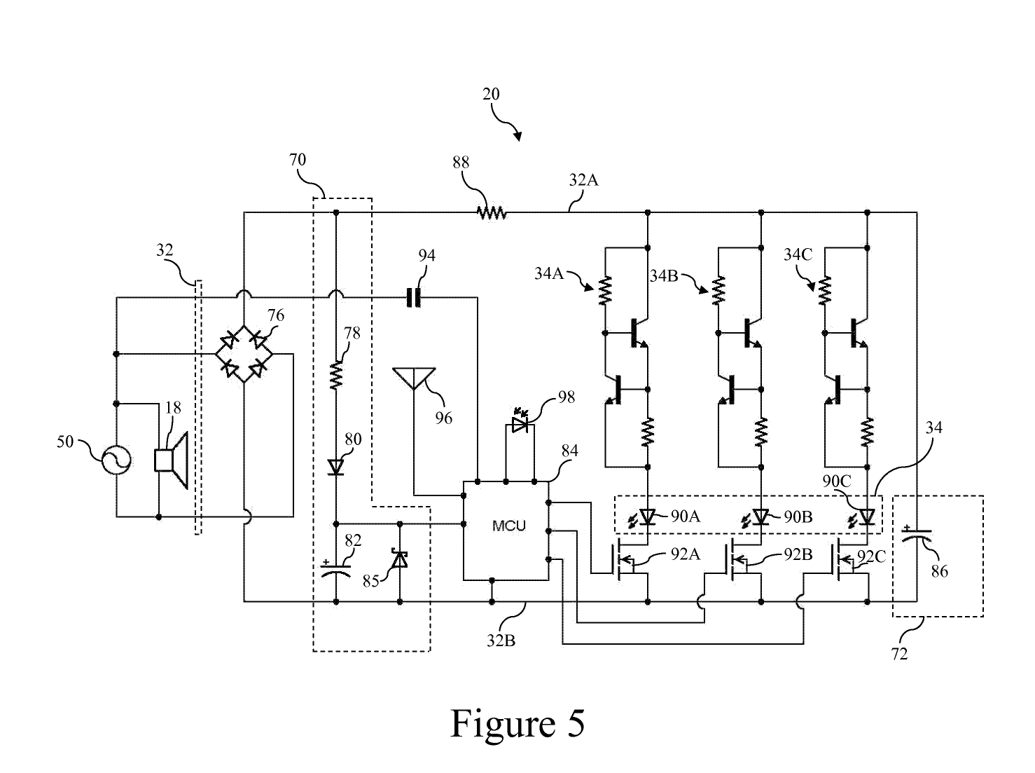

Referring to FIG. 5, an exemplary implementation of an illumination system 20 is illustrated, according to various aspects of the present invention. An opposing phase AC signal source, e.g., the speaker level audio frequency signal 50, supplies a signal to the speaker system 18 and to the exemplary illumination system 20. Particularly, the speaker level audio frequency signal 50 is coupled through the input 32 of the illumination system 20 to various components via the signal lines 32A, 32B, including the active current limiting circuitry 34 and illumination arrangement 36. The exemplary illumination system 20 also includes a first power distribution system 70 coupled to the input 32 for powering included digital controller circuitry 40. Moreover, a second power distribution system 72 is provided for the illumination arrangement 36.

A rectifier 76 is provided to rectify the AC signal 50. The first power distribution system 70 operates in combination with the output of the rectifier 76, and includes a series circuit comprising a resistor 78, a diode 80 and a capacitor 82 to convert the rectifier output to a DC voltage suitable for powering a microcontroller 84. An optional voltage device 85, such as a zener diode, voltage regulator or other active device may also optionally be positioned to limit or otherwise regulate the DC voltage applied to power the microcontroller 84. Under this configuration the resistor 78 limits surge current draw of capacitor 82 and provides additional signal isolation to maintain system fidelity. In this regard, the microcontroller 84 is powered by the speaker level audio frequency signal 50.

The resistor 78, diode 80 and capacitor 82 provide a separate power source to the microcontroller 84, e.g., such that the microcontroller 84 can operate under different conditions than the illumination devices of the illumination arrangement 36. For lowest current draw, the voltage device 85 such as a zener may be replaced with conventional fixed voltage regulator. Alternatively, a zener can be left in circuit, for example, where the zener is chosen to exhibit a low leakage current below the break-over. Specifying a zener to keep the supplied voltage near the maximum power requirements for the microcontroller with a particularly large voltage range may work acceptably under suitable conditions. As will be described in greater detail herein, the first power distribution system 70 includes the ability to store energy, for example via capacitor 82. This enables the first power distribution system 70 to keep the microcontroller 84 energized and operational, even when the speaker level audio frequency signal has stopped.

The second power distribution system 72 is implemented in the illustrative example by a capacitor 86. The capacitor 86 stores energy that may be utilized by the illumination devices in the absence of power provided by the speaker level, audio frequency signal 50. This enables for example smooth and gradual fades of the illumination devices and/or other effects to be implemented. The energy store for the first power distribution system 70 may be significantly larger than the energy store for the second power distribution system 72. In this regard, the processor 84 may remain energized and active, even after the illumination devices have drained the charge stored by the second power distribution 72. Still further, the energy store for the first and second power distribution systems can be implemented using other devices. For instance, the capacitor 82 and/or capacitor 86 may be replaced by a battery, a rechargeable source such as a rechargeable battery, etc. Still further, the microcontroller 84 can implement energy saving techniques, such as going into sleep or hibernation, e.g., when the speaker level audio signal is not providing power to the microcontroller 84 or a predetermined time thereafter. This allows the microcontroller 84 to wake up quickly, without requiring a reboot procedure.

In this regard, the illumination system 20, according to various aspects of the present invention, comprise a first power distribution system 70 coupled to the input 32 for powering the digital controller, e.g., the microcontroller 84. The first power distribution system comprises a first storage device for storing energy collected from the rectified speaker level, audio frequency signal for powering the digital controller in the absence of power provided by the speaker level, audio frequency signal. Moreover, a second power distribution system is provided for powering at least one channel of illumination devices comprising a second storage device for storing energy collected from the rectified speaker level, audio frequency signal for powering at least one illumination device in the absence of power provided by the speaker level, audio frequency signal.

Resistor 88 may optionally provided, for example to limit the overall current draw, e.g., for maximum fidelity.

In the illustrative example, three banks of illumination are provided. Each bank of illumination includes one or more illumination devices, such as light emitting diodes 90. In particular, a first network is electrically coupled between control lines 32A and 32B comprising a unique instance of the active current limiting circuitry 34A, a first bank consisting of one or more light emitting diodes 90A and a corresponding switch 92A. A second network is electrically coupled between control lines 32A and 32B comprising a unique instance of the active current limiting circuitry 34B, a second bank consisting of one or more light emitting diodes 90B and a corresponding switch 92B. Similarly, a third network is electrically coupled between control lines 32A and 32B comprising a unique instance of the active current limiting circuitry 34C, a third bank consisting of one or more light emitting diodes 90C and a corresponding switch 92C. By implementing unique instances of the current limiting circuitry 34, the particular characteristics of each bank of illumination devices can be calibrated, adjusted or otherwise manipulated. For instance, different colored light emitting diodes exhibit different current requirements. The ability to limit the current delivered to each bank at independent thresholds, for example organized by color of light emitting diode, enables comprehensive control over the intensity of each bank without risking over current conditions for a first bank to satisfy the current requirements of a second bank.

The microcontroller 84 can be utilized to implement various control schemes associated with the banks of illumination. As an illustrative example, the microcontroller 84 can receive an analog signal derived through the capacitor 94. In practice, a voltage divider or other circuitry may be provided to suitably scale the audio frequency signal. During operation, an internal Analog to Digital converter (ADC), voltage comparator, etc., within microcontroller 84 (or an external ADC if the microcontroller 84 is incapable of performing the ADC function) receives the analog signal. This signal may be employed, for example, as an input variable for calculation of subsequent illumination sequence triggering. For instance, the microcontroller 84 may perform operations on the digitized version of the audio frequency signal. By way of illustration, an envelope of the audio signal can control intensity, the frequency content, harmonic content or other signal attributes of the audio signal may drive color, light source selection, or any number of other parameters. Further, additional processing and signal analysis may be carried out to decide how to affect the illumination arrangement 36.

Moreover, programming information may also be conveyed to microcontroller 84 through an input connection along this input, e.g., via the content of the program material carried by the speaker level audio frequency signal 50, or via commands modulated or otherwise transmitted via the connecting cables that carry the speaker level audio frequency signal 50.

The optional antenna 96 is employed for microcontroller 84 to receive programming information. Further, optional communication circuitry 98, e.g., a photodiode, may be provided to facilitate communication such as using musical instrument digital interface (MIDI) commands or other digital communication networks such as DMX. In this regard, the microcontroller 84 may be controlled in accordance with program instructions received by the communication circuitry.

As illustrated, the microcontroller 84 includes an output to a control element of each switch 92A, 92B and 92C. Keeping with the above example, assume that the 3 banks of illumination devices are implemented as LEDs. Multiple colored LED's provide the ability to generate color changing illumination sequences. Moreover, the microcontroller 84 can control signal intensity of one or more of the banks of LEDS, e.g., using duty cycle modulation or other control techniques to drive the control elements of the switches.

As another illustration, LED(s) 90A of bank 1 may operate in the red spectrum. LED(s) 90B of bank 2 may operate in the green spectrum, and LED(s) 90C of bank 3 may operate in the blue spectrum. The respective active current limiting circuitry 34A, 34B and each limit the LED current draw of all LEDs in their corresponding bank in a manner that takes into consideration the unique current capabilities and requirements of the LED(s) in that bank. Additionally, the switches 92A, 92B and 92C may be implemented for example, as MOSFET switches. When a control element of a corresponding MOSFET switch 92A, 92B and 92C is driven high by the microcontroller 84, conduction through that MOSFET switch 92A, 92B and 92C results in current flow through the respective LED bank when sufficient voltage of the correct polarity is present across lines 32A, 3B, e.g., via the speaker level audio frequency signal or energy from the second power distribution system 72.

During operation, the microcontroller 84 is self-powered by the speaker level audio frequency signal or energy from the first power distribution system 70 collected and stored in response to the speaker level audio frequency signal. Moreover, the microcontroller 84, when powered up by the rectified power derived from the speaker level audio frequency signal, may trigger MOSFET switches 92A, 92B and 92C according to a programmed sequence or by actively receiving operating instructions, e.g., by a wireless communication received at the antenna 96 or via a control signal on a carrier type modulation for the speaker level audio frequency signal 50, or via the communication circuitry 98.

By employing an antenna and/or appropriate communication capabilities, wireless handheld devices and/or computer or digital networks may transmit information to the microcontroller 84, permitting either program sequence download or active real-time triggering. For instance, fans in an audience can use a software application running on a mobile cellular phone or other portable computing device to send requests, instructions or other information to the microcontroller 84, which can be interpreted as illumination sequence instructions. This provides not only dynamic, visual feedback, but also provides an opportunity for audience members to contribute to, and interact with the performance that they are experiencing.

The illustrated system using a microcontroller is presented by way of illustration and not by way of limitation. In practice, other configurations may alternatively be implemented. For instance, by utilizing banks of LEDs organized by color, it may be possible to replace the active current limiting circuitry with passive components or other arrangements.

As another illustrative example, according to various aspects of the present invention, an illumination system 20 may comprise an input 32 that receives a speaker level, audio frequency signal. The illumination system 20 may also include a digital controller that is powered by the speaker level audio frequency signal derived from the input, such as the microcontroller 84. An illumination arrangement 36, e.g., organized into a plurality of channels may be implemented where each channel comprises at least one illumination device such as an LED. Moreover, a plurality of switches may be utilized, each switch uniquely associated with a corresponding one of the channels. In this regard, each channel is coupled between a corresponding one of the switches and a connection that receives the speaker level, audio frequency signal. Moreover, the digital controller may be programmed or otherwise configured to comprise an output coupled to a control input of each switch such that each illumination device of a corresponding channel is controlled to illuminate at least during the simultaneous occurrence of an audio frequency speaker level signal capable of providing sufficient current to illuminate the corresponding channel, and the digital controller closing the corresponding switch.

Alternatively, this configuration of the illumination system 20 may comprise active current limiting circuitry 34 electrically coupled between the input 32 and the illumination arrangement 36, where the active current limiting circuitry 34 has at least one active semiconductor device for limiting the current allowed to pass there through. Still further, in a manner analogous to that described in greater detail herein, the active current limiting circuitry may electrically coupled to the input 32 in such a way that the active current limiting circuitry 34 has at least one active semiconductor device associated with each channel for independently limiting the current allowed to pass through the corresponding channel.

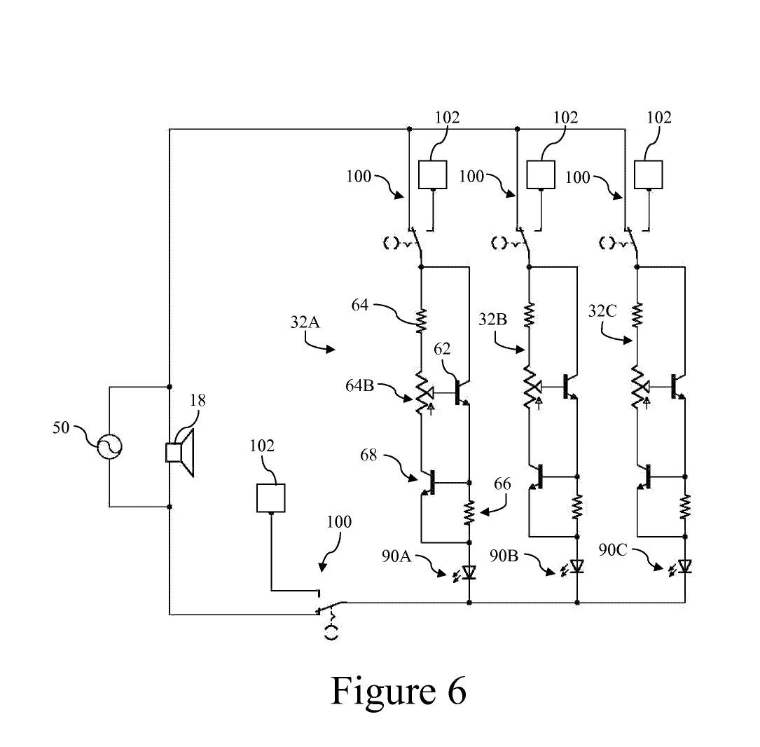

Referring to FIG. 6, a portion of an exemplary illumination system 20 is illustrated according to certain aspects of the present invention. The illustrated example includes features similar to that described with reference to FIG. 5. As such, like features will not be discussed in further detail. The circuit in FIG. 6 comprises a multiple current limit Led driver with variable intensity. Particularly, one or more switches 100 are utilized to allow a user to switch the LED driving source from the depicted speaker level audio frequency signal 50 to the alternate input. This alternate input may be an alternating voltage from another channel of an amplifier, external LED controller, e.g., such as a DMX illumination supply, a fixed reference voltage, et. In practice, the controls 100 may be ganged together or otherwise linked, e.g., using electronic switching, to allow for a more user-friendly control interface.

Also as illustrated, the active current limiting circuitry 34 is illustrated in yet another exemplary implementation. This exemplary implementation utilizes a second bias resistor that is similar to the rheostat 64B illustrated in FIG. 4. However, in this illustrative implementation, a second bias resistor 64B is implemented as a potentiometer where the outer terminals of the potentiometer are connected between the bias resistor 64 and the collector of the current sensing transistor 68. The wiper of the potentiometer connects to the base of the past transistor 62. In practice, the potentiometer can be omitted and/or implemented in other ways, e.g., as a rheostat in a manner analogous to that described with reference to FIG. 4.

Thus, according to further aspects of the present invention, an illumination system 20 may comprise an input 32 that receives a speaker level, audio frequency signal 50. The illumination system 20 may further comprise active current limiting circuitry 34 having at least one active semiconductor device for limiting the current allowed to pass there through. An illumination arrangement 36 having at least one illumination device is coupled to the active current limiting circuitry 34 in such a way that the active current limiting circuitry limits the current delivered there to. Moreover, the illumination system 20 may comprise a control device, such as the switch or switches 100, positioned between the input 32 and the active current limiting circuitry 34. In this regard, the control device 100 implements at least a first state wherein the active current limiting circuitry electrically couples the input carrying the speaker level, audio frequency signal to the illumination arrangement and a second state wherein the active current limiting circuitry is electrically disconnected from the input and is electrically connected to a control source. For instance, the control source may comprise at least one of a second speaker level, audio frequency signal from a second amplifier source, an external light controller and a fixed reference.

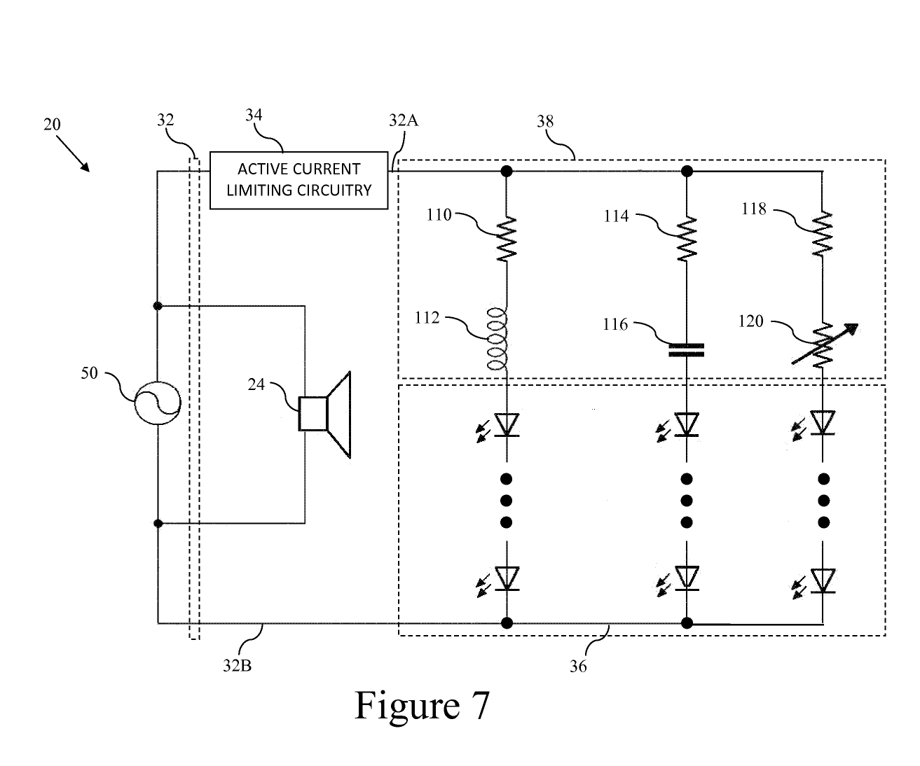

Referring to FIG. 7, a few exemplary implementations of the optional filter and conditioning circuitry 38 are presented by way of illustration and not by way of limitation of filtering and/or conditioning techniques that may be implemented. An opposing phase AC signal source, e.g., the speaker level audio frequency signal 50, supplies an audio frequency signal to speaker system 18 and to the illumination system 20. In the illustrative example, the illumination arrangement 36 of the illumination system 20 is implemented for purposes of illustration, using three banks of illumination devices. In this manner, optional conditioning circuitry 38 is analogously implemented in three banks. The exemplary first bank in the conditioning circuitry 38 includes a series circuit including a resistor 110 and a filter inductor 112. The exemplary second bank in the conditioning circuitry 38 includes a series circuit including a resistor 114 and a filter capacitor 116. The exemplary third bank in the conditioning circuitry 38 includes a series circuit including a resistor 118 and a variable resistor 120.

Also, in the illustrative configuration, the active current limiting circuitry 34 serves the purpose of limiting the current for the three banks of the illumination arrangement 36. In this regard, the active current limiting circuitry 34 acts as a master current limiter for all of the light emitting diodes in the illustrated three banks, further illustrating the diversity of this feature.

As an illustrative example, assume that the LEDs in the first bank of the illumination arrangement 36 emit similar wavelengths of red light. Likewise, the LEDs in the second bank of the illumination arrangement 36 emit yellow light and the LEDs in the third bank of the illumination arrangement 36 emit green light. The potentiometer 120 provides a user adjustable control for the intensity of the green LEDs. In this regard, a potentiometer could also be included in each of the other banks so as to operate in an analogous manner. Notably, because each bank in the illumination arrangement 36 is a different color, allowing the user to modify the individual wavelength intensities, e.g., via the potentiometer 120 on one or more channels, via digital controller circuitry such as using the microcontroller 84, etc., results in an alterable color spectrum, e.g., by effectively turning off certain colors or by blending the colors at relatively different intensities, at the operator's discretion. This may be quite advantageous in situations where a particular mood desired.

During operation, low frequency signal content of the speaker level audio frequency signal 50 passes through the filter inductor 112 and causes forward conduction in the first bank/LED array, resulting in the emission red light. High frequency signals are blocked by the low pass characteristics of the filter inductor 112 and do not result in subsequent red illumination. High frequency signal content of the speaker level audio frequency signal 50 passes through the filter of the second bank via the high pass filter capacitor 116 and causes forward conduction in the second bank/LED array, resulting in emitting yellow light. Correspondingly, low frequency signal content of the speaker level audio frequency signal 50 is blocked by the filter of the second bank via the high pass filter capacitor 116. If the speaker level audio frequency signal 50 comprises a composite signal of high and low frequency components driving speaker system 18, the apparatus will emit both red and yellow light that mix in intensity according to the relative signal level of the low and high frequency components. This effect has been found to emphasize rock and roll guitar signal and the conveyed emotion very well.

In general, the various configurations of illumination system 20 described more fully herein, provide for a number of signal processing techniques for controlling the illumination devices of the illumination arrangement 36. Exemplary signal processing techniques include: User adjustability for purposes of controlling color; User adjustability for purposes of controlling intensity; Program dependant adjustability of color; Program dependant adjustability of intensity; Filters for controlling color based upon frequency content; and Intensity based upon level of speaker level output.

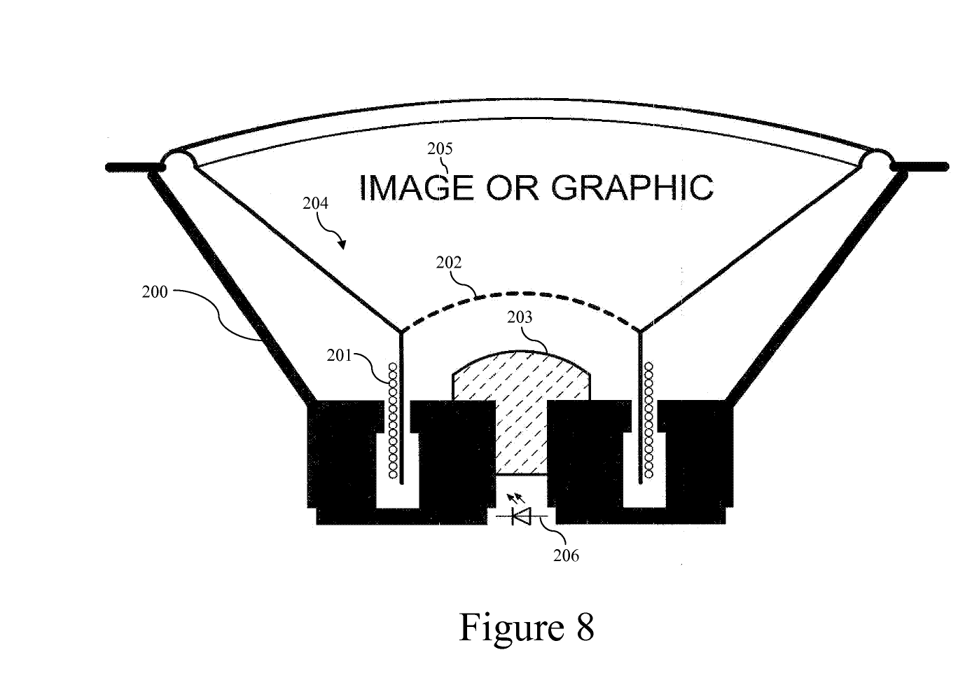

Referring to FIG. 8, an electro acoustic loudspeaker 200 is illustrated showing exemplary placement of an illumination LED and/or printed graphic. The loudspeaker 200 may, for example, implement an exemplary illuminated speaker 26 illustrated with reference to FIG. 2. In particular, the voice coil 201 receives the same alternating voltage that provides power for the illumination LED 206 e.g., illumination devices of the illumination arrangement 36 in a manner analogous to that described in greater detail herein. In this regard the LED 206 can be implemented as part of the illumination arrangement 36 as described in greater detail herein. A light dispersing plug 203 is placed behind a light permeable dust cap 202. For example, a piece of sandblasted plastic, such as clear acrylic, provides good light dispersion properties. A molded plastic lens assembly may also be employed to provide for patterns to be projected on loudspeaker cone 204. Many different materials are available and commonly used for dust caps. It is possible that the dust cap be made of a clear or translucent plastic or loose weave fabric to provide for means of light transmission. In an exemplary implementation, an image 205 is printed on the loudspeaker motor cone. If carefully applied and not excessively thick, certain paint does not create any alteration of the measured acoustic performance of the loudspeaker.

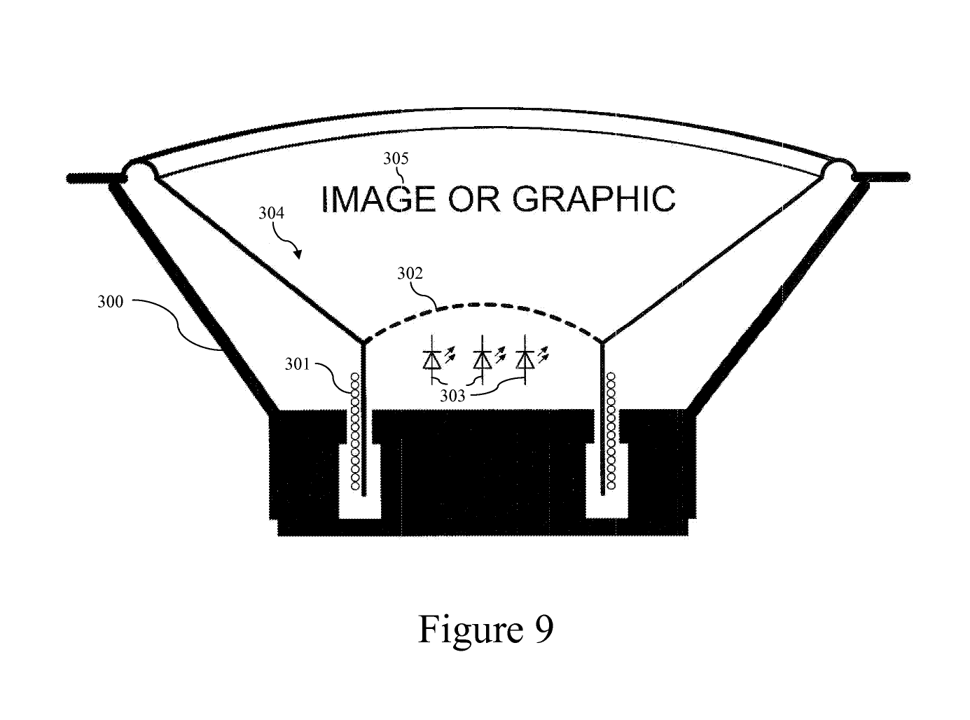

Referring to FIG. 9, an electro acoustic loudspeaker 300 is illustrated showing placement exemplary illumination LED's and printed graphic. The loudspeaker 300 may, for example, implement an exemplary illuminated speaker 26 illustrated with reference to FIG. 2. The voice coil 301 receives the same alternating voltage that provides power for the illumination LED's 303, e.g., illumination devices of the illumination arrangement 36 in a manner analogous to that described in greater detail herein. A light permeable dust cap 302 allows the LED's illumination to pass through the dust cap and illuminate the loudspeaker cone 304. As such, an image 305 becomes clearly visible in darkened environments by means of this illumination system.

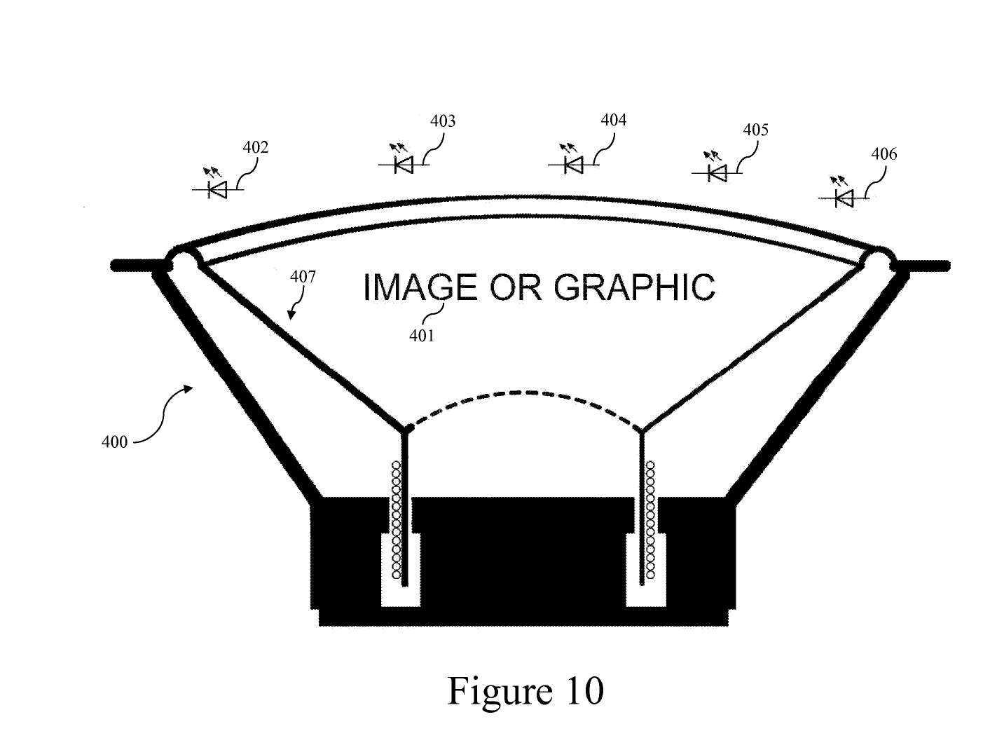

Referring to FIG. 10, an electro acoustic loudspeaker 400 is illustrated along with a series of LED's placed around the loudspeaker periphery. The loudspeaker 400 may, for example, implement an exemplary illuminated speaker 26 illustrated with reference to FIG. 2. LED's 402, 403, 404, 405, and 406, e.g., illumination devices of the illumination arrangement 36 in a manner analogous to that described in greater detail herein, illuminate the speaker cone 407 and thereby make an image or graphic 401 printed on the speaker cone, visible in low visibility.

Illumination provides both visual appeal and a means for interactive feedback between user and electronics and speaker system. As noted in greater detail herein, the illumination system is powered and may be programmed through the same alternating signal that drives the loudspeaker voice coil or programmed by other, such as by wireless means. For instance, loudspeakers are illuminated by means of LEDs that are powered by the alternating signal that drive the loudspeaker voice coils, e.g., via the electronics of the illumination system 20. Because of the low power requirements of the LED's and their relatively high efficiency, very little signal loss or distortion is introduced.

There are various different systems and methods that may be employed to achieve the desired illumination goals. In a first, exemplary simple system, LED's of the illumination arrangement 36 may be of a single color and may be simply wired in parallel with the loudspeaker voice coil. A series resistor, e.g., implemented by the conditioning/filter circuitry 38 may also be required for each LED or bank of series LEDs to limit the current through their respective LED junctions. The LED's will vary in intensity with the provided music. By adding an active current limiter 34 to the illumination system 20 and paralleling the LED's, illumination may be brought forth at a lower threshold than with series wired LED's with a series wired resistive current limiter.

As yet a further exemplary illustration, multiple color LED's of the illumination arrangement 36 may be employed and connected to the audio voltage signal by a crossover type network to provide a color changing response that varies with frequency components of the audio signal, e.g., as described with reference to FIG. 7. Still further, an illumination system 20 can be employed where different color LED's of the illumination arrangement 36 are incorporated in the speaker and amplifier system with an additional provision for the user to selectively adjust the current levels to each LED color bank, whereby permitting alterable system color at the users discretion.

In a more elaborate exemplary system, digital controller circuitry 40, e.g., using a microcontroller, is powered by the audio signal and can be utilized to control a lighting sequence of illumination devices of the illumination arrangement 36. A program sequence may be delivered to the microcontroller from the audio signal wires or by wireless means. The system may be preprogrammed for a fixed routine, or may have the program sequences actively loaded or triggered during the performance. The microcontroller generated control signals drive semiconductor switches to duty cycle modulate LED intensity.

Placement of the illumination LED's of the illumination arrangement 36 may be important in certain implementations to achieve the desired lighting effect. Several different placement options are available. For instance, the LED or LED's may be placed behind the loudspeaker magnet assembly of a speaker 26. A hole drilled through the back of the speaker motor permits the directed illumination to project on a light dispersing material. This material may be anything from a piece of sandblasted plastic to a more complex lens assembly creating visually appealing patterns on the speaker cone. The dust cap in this loudspeaker must be made of a light permeable material to permit some degree of illumination to pass through.

A possible modification to this arrangement may be to place the LED's directly behind the transparent loudspeaker dust cap. LEDs may also be arranged on the outside of the speaker cone and oriented to project their light onto the speaker cone whereby eliminating the need for a light permeable dust cap. Still further, illumination devices such as LEDs of the illumination arrangement 36 may be arranged around the periphery of a corresponding speaker 26, e.g., as illustrated in FIG. 2. In this regard, at least one illumination device is placed so as to direct illumination to a corresponding speaker cone assembly. The speaker cone assembly may be printed, as described herein, for an even further striking presentation.

Illumination LED's may be placed within the chassis of the electronic equipment and supplied power by the very same AC signal that drives the loudspeaker voice coils. This system creates a very striking visual effect when both electronics and speakers operate together in sequence to the music signal and program, again, as best illustrated in FIG. 2.

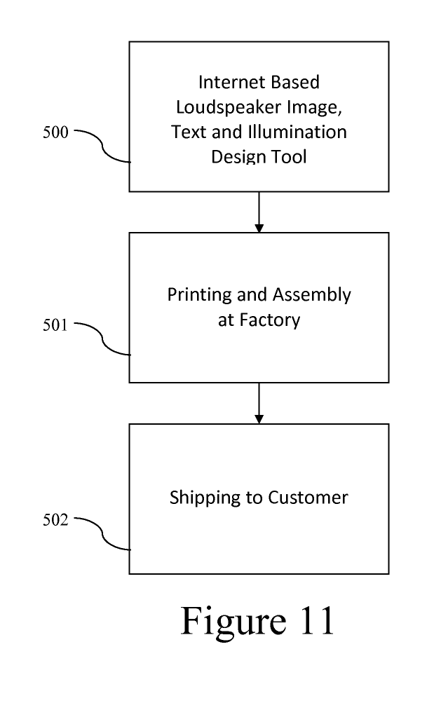

Referring to FIG. 11, a process enabling a customer of a loudspeaker to design the decorative attributes for the loudspeaker, where after customer submission, the loudspeaker cone is printed on and then shipped to customer. Step 500 indicates the customer's step in the process of designing and printing graphics on the loudspeaker cone. As illustrated, an internet-based design tool is provided where the customer has the opportunity to select either pre-designed artwork or draw and or submit their own. After submission, the factory in step 501 prints the graphic onto the loudspeaker cone. As described previously herein, any printing or painting method may be employed. Some methods include hand, airbrush, industrial inkjet and pad printing. After printing, the factory ships speaker to customer, as represented by step 502.

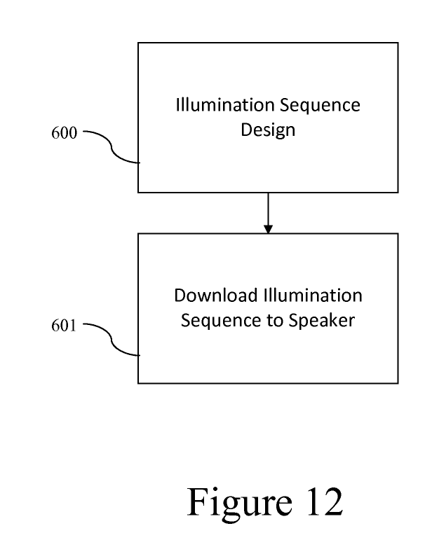

Referring to FIG. 12, a process where either the factory or customer may design and load a desired program to a loudspeaker if said loudspeaker is configured to receive programming information. The illumination sequence is designed in step 600. This step may take the way of many different forms. An internet based software application may be employed as the design tool. Moreover, a handheld device or personal computer without connection to internet may be employed if the illumination sequence programming software is held within its memory. The step of downloading the file to the loudspeaker may be realized in several different ways. In step 601, a wireless download may provide an easy and user friendly method of loading the program onto the loudspeaker embedded controller. The program or illumination sequence may also be transmitted to the embedded microcontroller by signal over power line type of technology. In this way, the audio frequency signal that drives the loudspeaker voice coil is the carrier where a signal of a type not to interfere with the acoustical properties of the system is conveyed through the very same conductors.

As noted in greater detail herein, systems and methods are provided, wherein a user may obtain custom indicia on their speaker of choice. Moreover, illumination systems are described herein, which enable a speaker and/or speaker cabinet and/or amplifier to be illuminated. In this regard, a user may design a custom illumination system and select additional embellishments such as custom printing of images texts, logos or graphics on the cones of the desired speakers. Thus, the speaker cones themselves may be printed to increase user appeal and improve marketing and visibility.

Speaker assemblies are then printed, and assembled. Software based programming may provide additional functionality to the system. If an illumination system employing a programmable computer is employed, the program may either be loaded at factory or by user at a later time of the user's discretion.

Various aspects of the present invention include an internet based speaker image and graphics selection design tool to enable the purchaser of the loudspeaker to select and incorporate an image of his or her choosing to be printed directly on the loudspeaker cone. This enables, for example, musicians and purchasers of electronics equipment, an internet based process whereby customer requested and or supplied graphics and text is sent to manufacturers and printed on their loudspeaker cones prior to purchase and delivery.

The customer requested image or text may be printed on the speaker cone by any available printing methods. For large production runs, a pad printing or ‘tampon’ printing machine may be employed because of its ease in printing complex images on curved surfaces. This printing process may best be done before the speaker cone is merged with the other components that make up the loudspeaker motor. For smaller production runs or one of a kind printing, an industrial inkjet printer easily achieves the printing task. The advantage of an industrial inkjet printer is that speaker cones may be printed in line during manufacture without the excessive need for specialized skills or additional human operators.

As yet a further illustrative example, a method of enabling a customer to design a decorative attribute of a loudspeaker is provided, which comprises receiving a submission of a graphical design from a customer via a computer interface over the internet, printing a speaker with the graphics design submitted by the customer and shipping the printed speaker to the customer. The method may further comprise modifying the speaker to include at least one illumination device that is driven to illuminate according to the signal applied to the voice coil of the speaker. For instance, a speaker can be modified to include an illumination system 20, e.g., as described more fully herein.

In this regard, the method may further comprise modifying the speaker to include an illumination system having an input that receives a speaker level, audio frequency signal, active current limiting circuitry electrically coupled to the input, the active current limiting circuitry having at least one active semiconductor device for limiting the current allowed to pass there through and an illumination arrangement having at least one illumination device coupled to the active current limiting circuitry so as to be driven by the audio frequency speaker level signal received by the input in such a way that the active current limiting circuitry limits the current delivered to at least one illumination device.

Moreover, the illumination system 20 added to a speaker may include programmable digital controller circuitry coupled to at least one illumination device of the illumination arrangement. In this regard the method may further comprise programming the digital controller circuitry before shipping the speaker to the customer to include at least one predetermined program sequence. For instance, the method may utilize the interface configured to comprise a design program that allows the customer to design the predetermined program sequence loaded into the digital controller circuitry. As another illustrative example, the interface may comprise a design program that allows the customer to design the graphic printed onto the speaker.

Still further, where the customer does not want a speaker permanently modified to include an illumination arrangement, a retrofit kit may be provided. For instance, the illumination arrangement 36 of an implementation of an illumination system 20 may be constructed as an illumination ring that surrounds the periphery of the speaker, e.g., and can be mounted to a corresponding speaker cabinet. Still further, the customer can order a custom printed speaker by ordering a new speaker, or the customer can pre-ship the speaker for printing of an existing speaker.

The above description is and not restrictive. Many variations of the invention will become apparent to those of skill in the art upon review of this disclosure. The scope of the invention should, therefore, be determined not with reference to the above description, but instead should be determined with reference to the appended claims along with their full scope of equivalents.

The embodiments discussed herein are illustrative examples of the present invention. As these embodiments of the present invention are described with reference to illustrations, various modifications or adaptations of the methods and/or specific structures described may become apparent to those skilled in the art. All such modifications, adaptations, or variations that rely upon the teachings of the present invention, and through which these teachings have advanced the art, are considered to be within the scope of the present invention. Hence, these descriptions and drawings should not be considered in a limiting sense, as it is understood that the present invention is in no way limited to only the embodiments illustrated.

Having thus described various embodiments of the present invention in detail herein, it will be apparent that modifications and variations are possible without departing from the scope of the embodiments of the present invention defined in the claims.

What is claimed is:

1. An illumination system comprising:
an input that receives a speaker level, audio frequency signal;
active current limiting circuitry electrically coupled to the input, the active current limiting circuitry having at least one active semiconductor device for limiting the current allowed to pass there through; and
an illumination arrangement having at least one illumination device coupled to the active current limiting circuitry so as to be driven by the audio frequency speaker level signal received by the input in such a way that the active current limiting circuitry limits the current delivered to at least one illumination device.

2. The illumination system according to claim 1, wherein:
the active current limiting circuitry and at least one illumination device are powered entirely by the speaker level audio frequency signal.

3. The illumination system according to claim 2, wherein:
the active current limiting circuitry comprises:
a pass transistor to normally allow an audio frequency, speaker level signal applied to the input, to pass there through;
a current sensing resistor in series with the pass transistor, which measures the audio frequency, speaker level signal passing there through; and
a current sensing transistor coupled to the current sensing resistor, the current sensing transistor configured to control the pass transistor when the current through the current sensing resistor obtains a predetermined current limiting value.

4. The illumination system according to claim 3, wherein:
the pass transistor and the sense transistor each comprise a collector, an emitter and a base;
the collector of the pass transistor is coupled to the input for receiving the audio frequency, speaker level signal;
the emitter of the pass transistor is coupled to the base of the current sensing transistor;
the current sensing resistor is coupled between the base and the emitter of the current sensing transistor; and
the collector of the current sensing transistor is coupled to the base of the pass transistor;
further comprising:
a bias resistor coupled between the collector and the base of the pass transistor, wherein the bias resistance is variable to control the current limiting threshold of the active current limiter.

5. The illumination system according to claim 1, wherein:
the illumination arrangement comprises a plurality of illumination devices implemented as light emitting diodes;
the active current limiting circuitry acts as a master current limiter for all of the light emitting diodes.

6. The illumination system according to claim 1, wherein:
the illumination arrangement comprises a plurality of illumination devices implemented as light emitting diodes;
the light emitting diodes are organized into a plurality of channels, each channel comprising at least one light emitting diode; and
the active current limiting circuitry comprises at least one active semiconductor device for limiting the current allowed to pass to each channel such that each channel has independent current limiting.

7. The illumination system according to claim 1, wherein:
at least one illumination device is mounted directly to a speaker.

8. The illumination system according to claim 7, wherein:
at least one illumination device is placed below a dust cap of a loudspeaker motor of the speaker.

9. The illumination system according to claim 7, wherein:
at least one illumination device is placed behind a magnet assembly of a loudspeaker motor of the speaker such that illumination is directed through a center pole and on to the speaker cone assembly.

10. The illumination system according to claim 7, wherein:
at least one illumination device is placed around a periphery of a speaker so as to direct illumination to a corresponding speaker cone assembly.

11. The illumination system according to claim 1, wherein:
at least one of: color and intensity of at least one illumination device is user-adjustable.

12. The illumination system according to claim 1, wherein:
the color of the illumination system is altered as a function of the signal frequency component of the speaker level, audio frequency signal.

13. The illumination system according to claim 1, wherein:
the input, active current limiting circuitry and the illumination arrangement are distributed between select ones of: an amplifier housing, a speaker cabinet, and at least one speaker.

14. An illumination system comprising:
an input that receives a speaker level, audio frequency signal;
active current limiting circuitry having at least one active semiconductor device for limiting the current allowed to pass there through;
an illumination arrangement having at least one illumination device coupled to the active current limiting circuitry in such a way that the active current limiting circuitry limits the current delivered there to; and
a control device positioned between the input and the active current limiting circuitry, the control device having at least:
a first state wherein the active current limiting circuitry electrically couples the input carrying the speaker level, audio frequency signal to the illumination arrangement; and
a second state wherein the active current limiting circuitry is electrically disconnected from the input and is electrically connected to a control source.

15. The illumination system according to claim 14, wherein:
the control source comprises at least one of:
a second speaker level, audio frequency signal from a second amplifier source;
an external light controller; and
a fixed reference.

16. An illumination system comprising:
an input that receives a speaker level, audio frequency signal;
a digital controller that is powered by the speaker level audio frequency signal derived from the input;
an illumination arrangement organized into a plurality of channels, each channel comprising at least one illumination device; and
a plurality of switches, each switch uniquely associated with a corresponding one of the channels;
wherein:
each channel is coupled between a corresponding one of the switches and a connection that receives the speaker level, audio frequency signal; and
the digital controller comprises an output coupled to a control input of each switch such that each illumination device of a corresponding channel is controlled to illuminate at least during the simultaneous occurrence of an audio frequency speaker level signal capable of providing sufficient current to illuminate the corresponding channel, and the digital controller closing the corresponding switch.

17. The illumination system according to claim 16, further comprising:
active current limiting circuitry electrically coupled between the input and the illumination arrangement, the active current limiting circuitry having at least one active semiconductor device for limiting the current allowed to pass there through.

18. The illumination system according to claim 16, further comprising:
active current limiting circuitry electrically coupled to the input, the active current limiting circuitry having at least one active semiconductor device associated with each channel for independently limiting the current allowed to pass through the corresponding channel.

19. The illumination system according to claim 16, further comprising:
a rectifier circuit for converting the speaker level, audio frequency signal to a direct current; and
a first power distribution system coupled to the input for powering the digital controller, the first power distribution system comprising:
a first storage device for storing energy collected from the speaker level, audio frequency signal for powering the digital controller in the absence of power provided by the speaker level, audio frequency signal.

20. The illumination system according to claim 19, further comprising:
a second power distribution system for powering at least one channel of illumination devices comprising:
a second storage device for storing energy collected from the speaker level, audio frequency signal for powering at least one illumination device in the absence of power provided by the speaker level, audio frequency signal.

21. The illumination system according to claim 16, wherein:
the outputs of the digital controller are controlled by the controller in accordance with program instructions received on a control signal modulated on the signal line that carries the speaker level audio frequency signal to the input.

22. The illumination system according to claim 16, further comprising:
an antenna for receiving wireless transmissions, wherein:
the digital controller is controlled in accordance with program instructions wirelessly received by the antenna.

23. The illumination system according to claim 16, further comprising:
communication circuitry for receiving commands transmitted as at least one of: MIDI and DMX for programming the digital controller;
the digital controller is controlled in accordance with program instructions received by the command control circuit.

24. A method of enabling a customer to design a decorative attribute of a loudspeaker, comprising:
receiving a submission of a graphical design from a customer via a computer interface over the internet;
printing a speaker with the graphics design submitted by the customer; and
shipping the printed speaker to the customer.

25. The method according to claim 24, further comprising:
modifying the speaker to include at least one illumination device that is driven to illuminate according to the signal applied to the voice coil of the speaker.

26. The method according to claim 24, further comprising:
modifying the speaker to include an illumination system having:
an input that receives a speaker level, audio frequency signal;
active current limiting circuitry electrically coupled to the input, the active current limiting circuitry having at least one active semiconductor device for limiting the current allowed to pass there through; and
an illumination arrangement having at least one illumination device coupled to the active current limiting circuitry so as to be driven by the audio frequency speaker level signal received by the input in such a way that the active current limiting circuitry limits the current delivered to at least one illumination device.

27. The method according to claim 26, wherein:
the illumination system further comprises programmable digital controller circuitry coupled to at least one illumination device of the illumination arrangement;
further comprising:
programming the digital controller circuitry before shipping the speaker to the customer to include at least one predetermined program sequence.

28. The method according to claim 27, wherein the interface comprises a design program that allows the customer to design the predetermined program sequence loaded into the digital controller circuitry.

29. The method according to claim 24, wherein the interface comprises a design program that allows the customer to design the graphic printed onto the speaker.
